(19) United States
(12) Patent Application Publication
(10) Pub. No.: US 2021/0119261 A1
(43) Pub. Date: Apr. 22, 2021

(54) ELECTROCHEMICAL DEVICE

(71) Applicant: Panasonic Intellectual Property Management Co., Ltd., Osaka (JP)

(72) Inventors: HIDEO SAKATA, Osaka (JP); YUSUKE NAKAMURA, Osaka (JP); MASATOSHI TAKESHITA, Osaka (JP); MOTOHIRO SAKATA, Osaka (JP)

(21) Appl. No.: 16/975,169

(22) PCT Filed: Mar. 22, 2019
(86) PCT No.: PCT/JP2019/012025

§ 371 Date: Aug. 24, 2020

(30) Foreign Application Priority Data
Mar. 29, 2018 (JP) 2018-063630

(51) Int. Cl. H01M 10/0569; H01M 4/60; H01M 10/0525

(52) U.S. Cl. CPC H01M 10/0569; H01M 4/606; H01M 2300/0037; H01M 2300/004; H01M 10/0525

(57) ABSTRACT

An electrochemical device includes a positive electrode containing a positive electrode active material, a negative electrode containing a negative electrode active material, and an electrolytic solution. The positive electrode active material includes a conductive polymer, and the electrolytic solution includes a lithium salt and a nonaqueous solvent. The nonaqueous solvent contains a first solvent and a second solvent. The first solvent includes γ-butyrolactone, and the second solvent includes at least one selected from the group consisting of an unsaturated cyclic carbonate ester and a cyclic carboxylic acid anhydride.

### TECHNICAL FIELD

The present invention relates to an electrochemical device that includes an active layer containing a conductive polymer.

### BACKGROUND

In recent years, an electrochemical device having performance intermediate between a lithium ion secondary battery and an electric double layer capacitor attracts attention, and for example, use of a conductive polymer as a positive electrode material is considered (for example, PTL 1). The electrochemical device including the conductive polymer as the positive electrode material has a small reaction resistance because it is charged and discharged by adsorption (doping) and desorption (dedoping) of anions. Thus, the electrochemical device has higher output than output of a general lithium ion secondary battery.

### CITATION LIST

### Patent Literature

PTL 1: Unexamined Japanese Patent Publication No. 2014-35836

### SUMMARY

Among various methods for charging the electrochemical device, for example, in float charging, a constant voltage is continuously applied to the electrochemical device. When the electrochemical device includes a positive electrode that includes an active layer containing a conductive polymer formed on a positive current collector, there would be a problem that the float charging tends to decrease capacitance along with a prolonged charging period.

In view of the above problem, an electrochemical device according to one aspect of the present invention includes a positive electrode containing a positive electrode active material, a negative electrode containing a negative electrode active material, and an electrolytic solution. The positive electrode active material includes a conductive polymer, and the electrolytic solution includes a lithium salt and a nonaqueous solvent. The nonaqueous solvent includes a first solvent and a second solvent. The first solvent includes γ-butyrolactone, and the second solvent includes at least one selected from the group consisting of an unsaturated cyclic carbonate ester and a cyclic carboxylic acid anhydride.

According to the present invention, a decline in a float property of the electrochemical device can be suppressed.

### BRIEF DESCRIPTION OF DRAWINGS

FIG. 1 is a schematic sectional view illustrating a positive electrode according to one exemplary embodiment of the present invention.

FIG. 2 is a schematic sectional view illustrating an electrochemical device according to the one exemplary embodiment of the present invention.

FIG. 3 is a schematic view illustrating a configuration of an electrode group according to the exemplary embodiment.

### DESCRIPTION OF EMBODIMENT

An electrochemical device according to the present exemplary embodiment includes a positive electrode containing a positive electrode active material, a negative electrode containing a negative electrode active material, and an electrolytic solution. The positive electrode active material includes a conductive polymer. The electrolytic solution includes a lithium salt and a nonaqueous solvent. The nonaqueous solvent includes a first solvent and a second solvent. The first solvent includes γ-butyrolactone, and the second solvent includes at least one selected from the group consisting of a cyclic carbonate ester containing an unsaturated bond (unsaturated cyclic carbonate ester) and a cyclic carboxylic acid anhydride.

It is presumed that the float property of the electrochemical device declines because internal resistance of the positive electrode would be increased during float charging. Output of the electrochemical device is decreased due to the increase of the internal resistance, and thus the capacitance decreases. This decrease in capacitance means the decline in the float property. Generally, an electrochemical device that includes a conductive polymer as a positive electrode active material tends to decline the float property.

The electrochemical device including a conductive polymer tends to generate gas in the float charging. The electrochemical device generates gas even at a charging voltage as low as about 3.6 V at which lithium ion secondary batteries do not cause a problem of generating gas. Thus, the generation of gas is considered to be not a problem of a negative electrode but a problem of the positive electrode including the conductive polymer.

In the electrochemical device, the conductive polymer is synthesized by electrolytic polymerization or chemical polymerization under a reaction solution containing a raw material monomer. Use of the reaction solution containing water as a solvent makes it difficult to completely remove water even by drying at a high temperature, because an amount of water taken in the conductive polymer is large. Hence, in a region near the positive electrode, a component contained in an electrolytic solution is considered to react with a small amount of water or the like that is present in the conductive polymer or the electrolytic solution, and to be oxidatively decomposed. This causes the increase of the internal resistance.

Hence, the present exemplary embodiment uses high oxidation-resistant solvent of γ-butyrolactone (GBL) as a main nonaqueous solvent (first solvent). This remarkably suppresses the oxidation decomposition of the electrolytic solution in the region near the positive electrode. And thus, the rise of the internal resistance at the float charging and the decline of the float property are suppressed.

Further, as for an accessory component, a second solvent is added as a covering film forming agent. By this component, a stable covering film is formed on a surface of a negative electrode active material to suppress a side reaction in a region near a negative electrode side. Hence, the rise of the internal resistance is further suppressed, and the effect of suppressing the decline of the float property is enhanced.

Since GBL has a low melting point and has high ion conductivity even at a low temperature, it is possible to maintain a low internal resistance of the electrochemical device even used in a low-temperature environment. Further, since GBL has a higher flash point than a flash point of a chain carbonate such as dimethyl carbonate (DMC), it is possible to ensure safety in liquid leakage of the electrochemical device.

On the other hand, when γ-butyrolactone (GBL) is used as the nonaqueous solvent, GBL is easily reductively decomposed in the region near the negative electrode. Thus, in order to suppress the rise of the internal resistance caused by the reductive decomposition of GBL in the region near the negative electrode, it is important to form a uniform and dense solid electrolyte interface (SEI) on the surface of the negative electrode active material. By adding an unsaturated cyclic carbonate ester and/or a cyclic carboxylic acid anhydride to the nonaqueous solvent, a uniform and dense covering film is formed on the surface of the negative electrode active material. Hence, the rise of the internal resistance is synergistically suppressed, and thus the decline of the float property is synergistically suppressed. In addition, an electrochemical device having a low initial resistance (direct current resistance (DCR)) can be obtained.

The second solvent includes an unsaturated cyclic carbonate ester and/or a cyclic carboxylic acid anhydride. The second solvent is capable of forming the dense solid electrolyte interface (SEI) on the surface of the negative electrode active material in a short time.

In production of an electrochemical device, a negative electrode is pre-doped with lithium ions. For example, by impregnating a negative electrode including a negative electrode active material layer on which a metallic lithium layer is formed with an electrolytic solution, lithium ions from the metallic lithium layer are eluted into the electrolytic solution. The eluted lithium ions are stored in the negative electrode active material. In this case, the lithium ions quickly move, so that a potential of the negative electrode can be rapidly decreased (to as low as near 0 V). A solid electrolyte interface formed on the surface of the negative electrode active material at this time is likely to be a non-uniform film that is lack of denseness.

In contrast, when the second solvent includes an unsaturated cyclic carbonate ester, a covering film that is highly dense and has high lithium-ion conductivity is formed, so that a highly dense solid electrolyte interface can be formed even in the above case.

The cyclic carboxylic acid anhydride can be quickly decomposed even at a relatively high potential of the negative electrode. Thus, the cyclic carboxylic acid anhydride can be reductively decomposed at high speed along with the rapid decrease in the potential of the negative electrode to form a dense covering film. Hence, when the second solvent includes the cyclic carboxylic acid anhydride, a more uniform and denser covering film is likely to be formed on the surface of the negative electrode active material.

Further, when the nonaqueous solvent contains the cyclic carbonate ester, a product generated by reductive decomposition of the cyclic carbonate ester can react with the covering film of the cyclic carboxylic acid anhydride to reconstruct the covering film into a denser and more uniform covering film.

In the unsaturated cyclic carbonate ester, a number of carbon atoms and a number of oxygen atoms that form a cyclic structure may be, for example, five or six, and is preferably five. The unsaturated bond is preferably formed between carbon atoms forming the cyclic structure, but is not necessarily limited to this example. Examples of the unsaturated cyclic carbonate ester include vinylene carbonate (VC), vinyl ethylene carbonate (VEC), and divinyl ethylene carbonate.

Among these examples, the cyclic carbonate ester preferably includes vinylene carbonate (VC).

In the cyclic carboxylic acid anhydride, a number of carbon atoms and a number of oxygen atoms that form a cyclic structure may be, for example, five or six, and is preferably five. One example of the cyclic carboxylic acid anhydride is maleic anhydride or succinic anhydride.

A proportion of the second solvent in the nonaqueous solvent ranges, for example, from 0.1% by mass to 10% by mass, inclusive. When the proportion of the second solvent in the nonaqueous solvent is set to be more than or equal to 0.1% by mass, a denser and more uniform covering film can be formed to suppress the increase of the internal resistance during the float charging and easily improve the float property. On the other hand, when the proportion of the second solvent in the nonaqueous solvent is set to be more than 10% by mass, film thickness of the covering film may excessively increase.

The proportion of the second solvent in the nonaqueous solvent may be more than or equal to 0.1% by mass, more than or equal to 1% by mass, more than or equal to 3% by mass. The proportion of the second solvent in the nonaqueous solvent may be less than or equal to 10% by mass, less than or equal to 7% by mass. Any combination of these upper limit values and lower limit values is possible.

The nonaqueous solvent may further contain ethylene carbonate (EC) or methyl propionate (MP) in addition to GBL. These compounds are expected to further reduce the initial resistance and give the effect of further improving the float property. In addition, since ethylene carbonate has a high relative dielectric constant, it is possible to improve performance of the electrochemical device also having a property as a capacitor on the positive electrode side. Further, ethylene carbonate has a higher flash point than the flash point of GBL to enable the electrochemical device to ensure safety in liquid leakage.

Ethylene carbonate, however, has a high melting point and therefore easily decreases the performance of the electrochemical device in a low-temperature environment. To deal with this problem, by adding methyl propionate, the decline of the performance in a low-temperature environment can be suppressed.

The first solvent and the second solvent may each include one type of solvent alone or two or more types of solvents in combination. The second solvent may include, in combination, at least one type of unsaturated cyclic carbonate ester and at least one type of cyclic carboxylic acid anhydride. In this case, the internal resistance can be further reduced, and thus the effect of suppressing the decline of the float property can be enhanced.

A proportion of γ-butyrolactone in the nonaqueous solvent other than the second solvent is, for example, more than or equal to 50% by mass, more than or equal to 60% by mass, more than or equal to 70% by mass, more than or equal to 90% by mass, or more than or equal to 95% by mass.

### <<Electrochemical Device>>

Hereinafter, a configuration of an electrochemical device according to the present invention is described in more detail with reference to drawings.

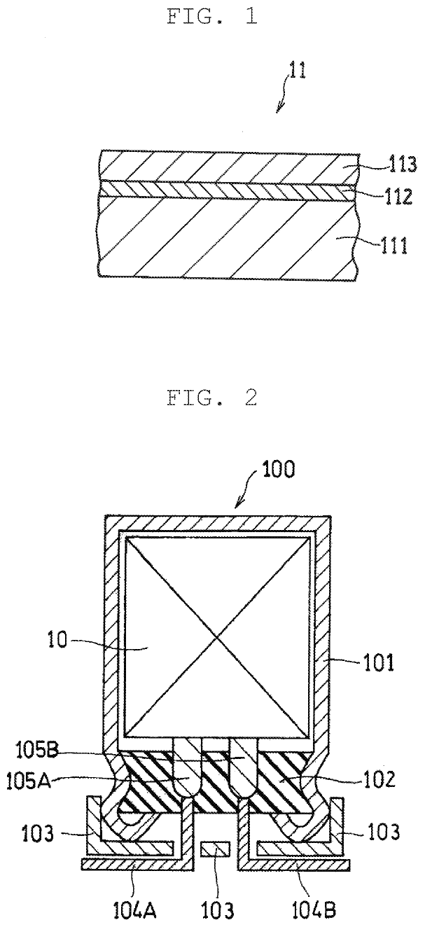

The electrochemical device according the present exemplary embodiment includes an electrode group including a positive electrode, a negative electrode, and a separator interposed between the positive electrode and the negative electrode. The positive electrode includes, as illustrated in FIG. 1, for example, positive current collector 111, carbon layer 112 formed on positive current collector 111, and active layer 113 formed on carbon layer 112. Active layer 113 includes a conductive polymer.

Positive current collector 111 is made of, for example, a metallic material, and a natural oxide covering film is easily formed on a surface of the positive current collector. Thus, in order to reduce resistance between positive current collector 111 and active layer 113, carbon layer 112 containing a conductive carbon material may be formed on positive current collector 111. Carbon layer 112 is formed by, for example, applying a carbon paste containing the conductive carbon material to the surface of positive current collector 111 to form a coating film and thereafter drying the coating film. The carbon paste is, for example, a mixture containing the conductive carbon material, a polymer material, and water or an organic solvent. As the polymer material contained in the carbon paste, generally used is, for example, an electrochemically stable fluorine resin, acrylic resin, polyvinyl chloride, synthetic rubber (e.g., styrene-butadiene rubber (SBR)), liquid glass (sodium silicate polymer), or imide resin.

As the conductive carbon material, it is possible to use, for example, graphite, hard carbon, soft carbon, and carbon black. Among these conductive carbon materials, carbon black is preferable in terms of easily forming carbon layer 112 that is thin and has excellent conductivity. An average particle diameter D1 of the conductive carbon material is not particularly limited, but ranges, for example, from 3 nm to 500 nm, inclusive, preferably from 10 nm to 100 nm, inclusive. The average particle diameter is a median diameter (D50) in a volume particle size distribution obtained by a laser diffraction particle size distribution measuring apparatus (the same applies hereinafter). The average particle diameter D1 of carbon black may be calculated by observation with a scanning electron microscope.

The positive electrode includes the positive current collector and conductive polymer layer (active layer) 113 formed on the positive current collector, and conductive polymer layer 113 is in contact with the separator.

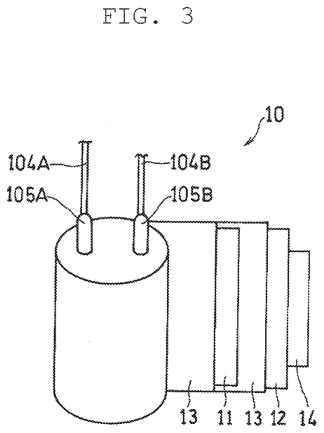

FIG. 2 is a schematic sectional view illustrating electrochemical device 100 according to the present exemplary embodiment, and FIG. 3 is a schematic developed view illustrating a part of electrode group 10 included in same electrochemical device 100.

As illustrated in FIG. 2, electrochemical device 100 includes electrode group 10, container 101 housing electrode group 10, sealing body 102 sealing an opening of container 101, base plate 103 covering sealing body 102, lead wires 104A, 104B lead out from sealing body 102 and penetrating base plate 103, and lead tabs 105A, 105B connecting the lead wires to the electrodes of electrode group 10, respectively. A part of container 101 near an opening end is drawn inward, and the opening end is curled to swage sealing body 102.

### (Positive Current Collector)

As the positive current collector, a sheet-shaped metallic material is used, for example. Used as the sheet-shaped metallic material are, for example, a metal foil, a metal porous body, a punched metal, an expanded metal, and an etched metal. As a material for positive current collector 111, it is possible to use, for example, aluminum, an aluminum alloy, nickel, and titanium, and preferably used are aluminum and an aluminum alloy. The positive current collector has a thickness ranging, for example, from 10 μm to 100 μm.

### (Active Layer)

Active layer 113 contains a conductive polymer. In the present exemplary embodiment, the conductive polymer includes a polyaniline. Active layer 113 is formed by, for example, immersing positive current collector 111 in a reaction solution containing a raw material monomer (that is, aniline) of the conductive polymer and electrolytically polymerizing the raw material monomer in presence of positive current collector 111. At this time, the electrolytic polymerization is performed, with positive current collector 111 set as an anode, to form active layer 113 containing the conductive polymer over a surface of carbon layer 112. Thickness of active layer 113 can be easily controlled by appropriately changing, for example, current density in electrolysis or a polymerization time. Active layer 113 has a thickness ranging, for example, from 10 μm to 300 μm. A weight-average molecular weight of the polyaniline is not particularly limited and ranges, for example, from 1000 to 100000.

The polyaniline refers to a polymer containing aniline (C₆H₅—NH₂) as a monomer and having an amine structural unit C₆H₅—NH—C₆H₅—NH— and/or an imine structural unit C₆H₅—N═C₆H₅═N—. Meanwhile, the polyaniline usable as the conductive polymer is not limited to these examples. The polyanilines (polyaniline or its derivatives) of the present invention includes, for example, a compound containing a benzene ring to a part of which an alkyl group such as a methyl group is attached and a derivative containing a benzene ring to a part of which a halogen group or the like is attached, as long as the compound and the derivative are polymers having a basic skeleton of aniline.

Active layer 113 may be formed by a method other than the electrolytic polymerization. Active layer 113 containing the conductive polymer may be formed by, for example, chemically polymerizing the raw material monomer. Alternatively, active layer 113 may be formed using a conductive polymer that has been prepared in advance or a dispersion or a solution of the conductive polymer.

Active layer 113 may includes a conductive polymer other than the polyanilines. As the conductive polymer usable together with the polyanilines, a it-conjugated polymer is preferable. As the it-conjugated polymer, it is possible to use, for example, polypyrrole, polythiophene, polyfuran, polythiophene vinylene, polypyridine, and derivatives of these polymers. A weight-average molecular weight of the conductive polymer is not particularly limited and ranges, for example, from 1000 to 100000. As a raw material monomer of the conductive polymer usable with the polyanilines, it is possible to use, for example, pyrrole, thiophene, furan, thiophene vinylene, pyridine, and derivatives of these monomers. The raw material monomer may include an oligomer.

Derivatives of polypyrrole, polythiophene, polyfuran, polythiophene vinylene, and polypyridine mean polymers having, as a basic skeleton, polypyrrole, polythiophene, polyfuran, polythiophene vinylene, and polypyridine, respectively. For example, a polythiophene derivative includes poly(3,4-ethylenedioxythiophene) (PEDOT) and the like.

When active layer 113 includes the conductive polymer other than the polyanilines, a proportion of the polyanilines in all the conductive polymers constituting active layer 113 is preferably more than or equal to 90% by mass.

The electrolytic polymerization or the chemical polymerization is preferably performed using a reaction solution containing a dopant. The dispersion liquid or the solution of the conductive polymer also preferably contains a dopant. An-electron conjugated polymer doped with a dopant exerts excellent conductivity. For example, in the chemical polymerization, positive current collector 111 may be immersed in a reaction solution containing the dopant, an oxidant, and the raw material monomer, and thereafter picked out from the reaction solution and dried. On the other hand, in the electrolytic polymerization, positive current collector 111 and an opposite electrode may be immersed in a reaction solution containing the dopant and the raw material monomer while current is flowed between the positive current collector and the opposite electrode, with positive current collector 111 set as an anode and the opposite electrode as a cathode.

As a solvent of the reaction solution, water may be used, or a nonaqueous solvent may be used in consideration of solubility of the monomer. As the nonaqueous solvent, for example, alcohols such as ethyl alcohol, methyl alcohol, isopropyl alcohol, ethylene glycol, and propylene glycol are preferably used. A dispersion medium or solvent of the conductive polymer is also exemplified by water and the nonaqueous solvents described above.

Examples of the dopant include a sulfate ion, a nitrate ion, a phosphate ion, a borate ion, a benzenesulfonate ion, a naphthalenesulfonate ion, a toluenesulfonate ion, a methanesulfonate ion (CF₃SO₃—), a perchlorate ion (ClO₄—), a tetrafluoroborate ion (BF₄—), a hexafluorophosphate ion (PF₆—), a fluorosulfate ion (FSO₃—), a bis(fluorosulfonyl)imide ion (N(FSO₂)₂—), and a bis(trifluoromethanesulfonyl)imide ion (N(CF₃SO₂)₂—). A single one or two or more in combination of these ions may be used.

The dopant may be a polymer ion. Examples of the polymer ion include ions of polyvinylsulfonic acid, polystyrenesulfonic acid, polyallylsulfonic acid, polyacrylsulfonic acid, polymethacrylsulfonic acid, poly(2-acrylamido-2-methylpropanesulfonic acid), polyisoprenesulfonic acid, and polyacrylic acid. These polymers may be a homopolymer or a copolymer of two or more monomers. A single one or two or more in combination of these polymer ions may be used.

The reaction solution, or the dispersion liquid of the conductive polymer or the solution of the conductive polymer preferably has a pH ranging from 0 to 4 in terms of easily forming active layer 113.

### (Negative Electrode)

The negative electrode includes, for example, a negative current collector and a negative electrode material layer.

As the negative current collector, a sheet-shaped metallic material is used, for example. As the sheet-shaped metallic material, for example, a metal foil, a metal porous body, a punched metal, an expanded metal, and an etched metal are used. As a material for the negative current collector, it is possible to use, for example, copper, a copper alloy, nickel, and stainless steel.

The negative electrode material layer preferably includes, as a negative electrode active material, a material that electrochemically stores and releases lithium ions. Examples of such a material include a carbon material, a metal compound, an alloy, and a ceramic material. As the carbon material, graphite, non-graphitizable carbon (hard carbon), and easily graphitizable carbon (soft carbon) are preferable, and graphite and hard carbon are particularly preferable. Examples of the metal compound include silicon oxide and tin oxide. Examples of the alloy include a silicon alloy and a tin alloy. Examples of the ceramic material include lithium titanate and lithium manganate. A single one or two or more in combination of these materials may be used. Among these materials, a carbon material is preferable in terms of being capable of decreasing the potential of the negative electrode.

The negative electrode material layer preferably includes a conducting agent, a binder, or the like in addition to the negative electrode active material. Examples of the conducting agent include carbon black and a carbon fiber. Examples of the binder include a fluorine resin, an acrylic resin, a rubber material, and a cellulose derivative. Examples of the fluorine resin include polyvinylidene fluoride, polytetrafluoroethylene, and a tetrafluoroethylene-hexafluoropropylene copolymer. Examples of the acrylic resin include polyacrylic acid and an acrylic acid-methacrylic acid copolymer. Examples of the rubber material include styrene-butadiene rubber, and examples of the cellulose derivative include carboxymethyl cellulose.

The negative electrode material layer is formed by, for example, mixing the negative electrode active material, the conducting agent, the binder, and the like with a dispersion medium to prepare a negative electrode mixture paste, and applying the negative electrode mixture paste to the negative current collector and then drying the negative electrode mixture paste.

The negative electrode is preferably pre-doped with lithium ions in advance. This decreases the potential of the negative electrode to increase a difference in potential (that is, voltage) between the positive electrode and the negative electrode and thus improve energy density of the electrochemical device.

Pre-doping of the negative electrode with the lithium ions proceeds by, for example, forming a metallic lithium layer that is to serve as a supply source of the lithium ions on a surface of the negative electrode material layer and impregnating the negative electrode including the metallic lithium layer with an electrolytic solution (e.g., a nonaqueous electrolytic solution) having lithium-ion conductivity. At this time, the lithium ions are eluted from the metallic lithium layer into the nonaqueous electrolytic solution, and the eluted lithium ions are stored in the negative electrode active material. For example, when graphite or hard carbon is used as the negative electrode active material, the lithium ions are inserted in between layers of the graphite or in fine pores of the hard carbon. An amount of the pre-doping lithium ions can be controlled by a mass of the metallic lithium layer.

The step of pre-doping the negative electrode with the lithium ions may be performed before assembling the electrode group, or the pre-doping may proceed after the electrode group is housed together with the nonaqueous electrolytic solution in a case of the electrochemical device.

### (Separator)

Preferably used as the separator are, for example, a nonwoven fabric made of cellulose fiber, a nonwoven fabric made of glass fiber, a microporous membrane made of polyolefin, a fabric cloth, and a nonwoven fabric. The separator has a thickness ranging, for example, from 10 μm to 300 μm, inclusive, preferably from 10 μm to 40 μm, inclusive.

### (Electrolytic Solution)

The electrode group includes an electrolytic solution.

The electrolytic solution has lithium-ion conductivity and contains a lithium salt and a nonaqueous solvent that dissolves the lithium salt. In this case, anions of the lithium salt are capable of reversibly repeating doping and dedoping to and from the positive electrode. On the other hand, lithium ions derived from the lithium salt are reversibly stored and released in and from the negative electrode.

Examples of the lithium salt include LiClO₄, LiBF₄, LiPF₆, LiAlCl₄, LiSbF₆, LiSCN, LiCF₃SO₃, LiFSO₃, LiCF₃CO₂, LiAsF₆, LiB₁₀Cl₁₀, LiCl, LiBr, LiI, LiBCl₄, LiN(FSO₂)₂, and LiN(CF₃SO₂)₂. A single one or two or more in combination of these lithium salts may be used. Among these lithium salts, at least one selected from the group consisting of a lithium salt having a halogen atom-containing oxo acid anion suitable as an anion, and a lithium salt having an imide anion is preferably used. Concentration of the lithium salt in the nonaqueous electrolytic solution may range, for example, from 0.2 mol/L to 4 mol/L, inclusive, and is not particularly limited.

The nonaqueous solvent includes the first solvent of γ-butyrolactone (GBL) as an essential solvent and includes the second solvent including the unsaturated cyclic carbonate ester and/or the cyclic carboxylic acid anhydride as an essential solvent. The nonaqueous solvent may also contain another solvent as an optional component.

As the optional component, it is possible to use, for example, cyclic carbonates such as ethylene carbonate, propylene carbonate, and butylene carbonate; chain carbonates such as dimethyl carbonate, diethyl carbonate, and ethyl methyl carbonate; aliphatic carboxylate esters such as methyl formate, methyl acetate, methyl propionate, and ethyl propionate; lactones such as y-valerolactone; chain ethers such as 1,2-dimethoxyethane (DME), 1,2-diethoxyethane (DEE), and ethoxymethoxyethane (EME); cyclic ethers such as tetrahydrofuran and 2-methyltetrahydrofuran; climethylsulfoxide, 1,3-dioxolane, formamide, acetamide, dimethylformamide, dioxolane, acetonitrile, propionitrile, nitromethane, ethylmonoglyme, trimethoxymethane, sulfolane, methyl sulfolane, and 1,3-propanesultone. A single one or two or more in combination of these optional components may be used. Among these optional components, ethylene carbonate and/or methyl propionate is preferably used.

By replacing a part of the first solvent of γ-butyrolactone (GBL) with ethylene carbonate and/or methyl propionate, the initial DCR can be further reduced and the float property can be further improved.

### (Manufacturing Method)

Hereinafter, one example of a method for manufacturing the electrochemical device of the present invention is described with reference to FIGS. 2 and 3. Meanwhile, the method for manufacturing the electrochemical device of the present invention is not limited to this example.

Electrochemical device 100 is manufactured by a method including the following steps, for example. The steps are applying a carbon paste to positive current collector 111 to form a coating film and then drying the coating film to form carbon layer 112; obtaining positive electrode 11 by forming active layer 113 containing a conductive polymer on the carbon layer; and stacking obtained positive electrode 11, separator 13, and negative electrode 12 in this order. Further, electrode group 10 obtained by stacking positive electrode 11, separator 13, and negative electrode 12 in this order is housed together with a nonaqueous electrolytic solution in container 101. Usually, active layer 113 is formed in an acidic atmosphere due to an influence of an oxidant or a dopant used.

A method for applying the carbon paste to positive current collector 111 is not particularly limited, and examples of the method include common application methods such as a screen printing method, a coating method using various coaters, e.g., a blade coater, a knife coater, and a gravure coater, and a spin coating method. The drying of the obtained coating film may be performed, for example, at a temperature from 130° C. to 170° C. for a period from 5 minutes to 120 minutes. In this way, dense film-shaped carbon layer 112 is easily formed.

Active layer 113 is, as described above, formed by, for example electrolytically polymerizing or chemically polymerizing a raw material monomer in presence of positive current collector 111 including carbon layer 112. Alternatively, the active layer is formed by coating positive current collector 111 including carbon layer 112 with, for example, a solution containing a conductive polymer or a dispersion of a conductive polymer.

A lead member (lead tab 105A equipped with lead wire 104A) is connected to positive electrode 11 obtained as described above, and another lead member (lead tab 105B equipped with lead wire 104B) is connected to negative electrode 12. Subsequently, positive electrode 11 and negative electrode 12 to which these lead members are connected are wound, with separator 13 interposed between the positive electrode and the negative electrode, to give electrode group 10 exposes the lead members from one end surface of electrode group 10, which is shown in FIG. 3. An outermost periphery of electrode group 10 is fixed with fastening tape 14.

Next, as shown in FIG. 2, electrode group 10 is housed together with a nonaqueous electrolytic solution (not shown) in bottomed cylindrical container 101 having an opening. Lead wires 104A, 104B are led out from sealing body 102. Sealing body 102 is disposed at the opening of container 101 to seal container 101. Specifically, container 101 is, at a part near an opening end, drawn inward, and is, at the opening end, curled to swage sealing body 102. Sealing body 102 is formed of, for example, an elastic material containing a rubber component.

In the exemplary embodiment, a wound cylinder-shaped electrochemical device has been described. Meanwhile, an application range of the present invention is not limited to the example described above, and the present invention is also applicable to a square or rectangle-shaped wound or stacked electrochemical device.

### EXAMPLES

Hereinafter, the present invention is described in more detail based on examples. Meanwhile, the present invention is not to be limited to the examples.

### <<Electrochemical Devices A1 to A16 and B1 to B3>>

(1) Production of Positive Electrode

A 30-μm-thick aluminum foil was prepared as a positive current collector. On the other hand, an aqueous aniline solution containing aniline and sulfuric acid was prepared.

A carbon paste obtained by kneading carbon black with water was applied to entire front and back surfaces of the positive current collector, and then dried by heating to form a carbon layer. The carbon layer had a thickness of 2 μm per one surface.

The positive current collector on which the carbon layer had been formed and an opposite electrode were immersed in the aqueous aniline solution containing sulfuric acid. And then electrolytic polymerization was performed at a current density of 10 mA/cm² for 20 minutes to attach a film of a conductive polymer (polyaniline) doped with sulfate ions (SO₄²⁻) onto the carbon layers on the front and back surfaces of the positive current collector.

The conductive polymer doped with sulfate ions was reduced for dedoping of the sulfate ions. In this way, an active layer containing the conductive polymer that had been subjected to dedoping of the sulfate ions was formed. Next, the active layer was sufficiently washed and thereafter dried. The active layer had a thickness of 35 μm per one surface.
(2) Production of Negative Electrode

A 20-μm-thick copper foil was prepared as a negative current collector. In the meantime, a negative electrode mixture paste was prepared by kneading a mixed powder containing 97 parts by mass of hard carbon, 1 part by mass of carboxy cellulose, and 2 parts by mass of styrene-butadiene rubber with water at a ratio by weight (the mixed powder:water) of 40:60. The negative electrode mixture paste was applied to both surfaces of the negative current collector, and dried to give a negative electrode including a 35-μm-thick negative electrode material layer on both surfaces. Next, a metallic lithium foil was attached to the negative electrode material layer in an amount calculated so that a potential of the negative electrode after pre-doping in an electrolytic solution would be less than or equal to 0.2 V with respect to a potential of metallic lithium.
(3) Production of Electrode Group

Lead tabs were respectively connected to the positive electrode and the negative electrode, and then, as illustrated in FIG. 3, a stacked body obtained by alternately stacking a nonwoven fabric separator (thickness 35 μm) made of cellulose, the positive electrode, and the negative electrode was wound to form an electrode group.
(4) Preparation of Electrolytic Solutions

Nonaqueous solvents were prepared by mixing a main solvent (first solvent) and an auxiliary solvent at mixing ratios indicated in Table 1. Further, a second solvent indicated in Table 1 was added. An addition amount of the second solvent was set so that the second solvent had a content proportion (wt %) indicated in Table 1 in an entirety of the nonaqueous solvent containing the second solvent. LiPF₆ was dissolved as a lithium salt in the obtained solvent at a prescribed concentration to prepare electrolytic solutions.
(5) Production of Electrochemical Devices

The electrode group and the electrolytic solution were housed in a bottomed container having an opening to assemble the electrochemical device shown in FIG. 2. Thereafter, the electrochemical device was aged under application of a charging voltage of 3.8 V between terminals of the positive electrode and the negative electrode at 25° C. for 24 hours and allowed pre-doping of the negative electrode with lithium ions to be progressed. Thus, electrochemical devices A1 to A16 and B1 to B3 were produced that had different compositions of the electrolytic solution. The electrochemical devices B1 to B3 are comparative examples.

TABLE 1

| | Main solvent | | Auxiliary solvent | | Second solvent | | | |
|---|---|---|---|---|---|---|---|---|
| | | Content | | Content | | Content | | Content |
| | | proportion | | proportion | | proportion | | proportion |
| | Compound | (wt %) | Compound | (wt %) | Compound | (wt %) | Compound | (wt %) |
| B1 | PC | 100 | | | VC | 3 | | |
| B2 | EC | 50 | DMC | 50 | VC | 3 | | |
| B3 | GBL | 100 | | | | | | |
| A1 | GBL | 100 | | | VC | 0.1 | | |
| A2 | GBL | 100 | | | VC | 0.5 | | |
| A3 | GBL | 100 | | | VC | 1 | | |
| A4 | GBL | 100 | | | VC | 3 | | |
| A5 | GBL | 100 | | | VC | 5 | | |
| A6 | GBL | 100 | | | VC | 7 | | |
| A7 | GBL | 100 | | | VC | 10 | | |
| A8 | GBL | 100 | | | Maleic | 0.1 | | |
| | | | | | anhydride | | | |
| A9 | GBL | 100 | | | Maleic | 5 | | |
| | | | | | anhydride | | | |
| A10 | GBL | 100 | | | Maleic | 10 | | |
| | | | | | anhydride | | | |
| A11 | GBL | 100 | | | Succinic | 0.1 | | |
| | | | | | anhydride | | | |
| A12 | GBL | 100 | | | Succinic | 5 | | |
| | | | | | anhydride | | | |
| A13 | GBL | 100 | | | Succinic | 10 | | |
| | | | | | anhydride | | | |
| A14 | GBL | 100 | | | Maleic | 2.5 | Succinic | 2.5 |
| | | | | | anhydride | | anhydride | |
| A15 | GBL | 100 | | | VC | 2.5 | Maleic | 2.5 |
| | | | | | | | anhydride | |
| A16 | GBL | 100 | | | VC | 2.5 | Succinic | 2.5 |
| | | | | | | | anhydride | |

TABLE 2

| | First solvent | | | | | |
|---|---|---|---|---|---|---|
| | Main solvent | | Auxiliary solvent | | | |
| | | Content | | Content | | Content |
| | | proportion | | proportion | | proportion |
| | Compound | (wt %) | Compound | (wt %) | Compound | (wt %) |
| A17 | GBL | 50 | EC | 50 | | |
| A18 | GBL | 60 | EC | 40 | | |
| A19 | GBL | 70 | EC | 30 | | |
| A20 | GBL | 90 | EC | 10 | | |
| A21 | GBL | 95 | EC | 5 | | |
| A22 | GBL | 75 | EC | 20 | MP | 5 |
| A23 | GBL | 75 | EC | 15 | MP | 10 |
| A24 | GBL | 75 | EC | 10 | MP | 15 |
| A25 | GBL | 75 | EC | 5 | MP | 20 |
| A26 | GBL | 70 | | | MP | 30 |

### <<Electrochemical Devices A17 to A26>>

In the preparation of the electrolytic solutions, γ-butyrolactone (GBL), ethylene carbonate (EC), and methyl propionate (MP) were mixed at mixing ratios indicated in Table 2 to prepare nonaqueous solvents. Subsequently, vinylene carbonate (VC) and succinic anhydride were added as the second solvent so that vinylene carbonate and succinic anhydride each became 2.5% by mass with respect to the entirety of the nonaqueous solvent containing the second solvent (that is, similarly to in the electrochemical device A16).

Except for the above, electrochemical devices A17 to A26 were produced similarly to the electrochemical devices A1 to A16.

### (Evaluations)

(1) Internal Resistance (DCR)

An initial internal resistance (initial DCR) was calculated from an amount of voltage drop after a predetermined time of discharging from a state the electrochemical device was charged at a voltage of 3.6 V. The initial internal resistance was represented by a relative value, with the initial internal resistance of the electrochemical device B2 defined as 100. Table 3 shows evaluation results.
(2) Float Property

A resistance value of the electrochemical device continuously charged for 1000 hours under conditions of 60° C. and 3.6 V was measured, and a change rate of the measured resistance value to a (initial) resistance value before the continuous charging was calculated by (resistance value after 1000-hour charging/initial resistance value)×100. The calculated change rate was represented by a relative value, with the change rate of the electrochemical device B2 defined as 100. Table 3 shows evaluation results.

TABLE 3

| | Initial DCR | Float property |
|---|---|---|
| B1 | 105.0 | 95.9 |
| B2 | 100 | 100 |
| B3 | 98.2 | 117.6 |
| A1 | 95.8 | 95.2 |
| A2 | 93.6 | 94.1 |
| A3 | 91.6 | 93.3 |
| A4 | 90.2 | 90.7 |
| A5 | 86.0 | 86.7 |
| A6 | 88.2 | 87.5 |
| A7 | 95.3 | 88.0 |
| A8 | 93.9 | 93.6 |
| A9 | 84.3 | 85.3 |
| A10 | 93.4 | 86.5 |
| A11 | 94.9 | 94.5 |
| A12 | 85.2 | 86.1 |
| A13 | 94.4 | 87.3 |
| A14 | 82.3 | 87.2 |
| A15 | 85.6 | 86.0 |
| A16 | 82.6 | 84.5 |
| A17 | 76.5 | 79.8 |
| A18 | 77.2 | 80.5 |
| A19 | 78.3 | 80.7 |
| A20 | 79.1 | 82.4 |
| A21 | 80.6 | 83.7 |
| A22 | 71.2 | 76.2 |
| A23 | 72.3 | 77.8 |
| A24 | 73.5 | 78.6 |
| A25 | 74.2 | 79.1 |
| A26 | 87.6 | 87.5 |

Table 3 gives results that the electrochemical devices A1 to A26 containing γ-butyrolactone (GBL) as the first solvent and the unsaturated cyclic carbonate ester and/or the cyclic carboxylic acid anhydride as the second solvent improved the initial DCR and the float property.

The electrochemical device B3 containing γ-butyrolactone (GBL) as the first solvent showed a slight improvement in the initial DCR compared to the devices B1 and B2. The device B3, however, was decreased in the float property compared to the devices B1 and B2. This is considered to be because GBL does not form a dense covering film on the surface of the negative electrode active material.

From comparison among the electrochemical devices A5, A9, A12, and A14 to A16, an excellent initial DCR and the effect of improving the float property can be expected by using the second solvent containing a plurality of compounds selected from the group consisting of an unsaturated cyclic carbonate ester and a cyclic carboxylic acid anhydride, compared with using the second solvent containing one compound at the same content proportion. The device A14 containing both maleic anhydride and succinic anhydride had a large improvement in the initial DCR, but was slightly lower in the float property than the devices A9 and A12 containing only either one of maleic anhydride and succinic anhydride. In terms of a balance between the initial DCR and the float property, a combination of vinylene carbonate (VC) and succinic anhydride is excellent as the second solvent.

The evaluation results for the electrochemical devices A17 to A26 show that the replacement of a part of GBL with ethylene carbonate and/or methyl propionate further improves the initial DCR and the float property.

### INDUSTRIAL APPLICABILITY

An electrochemical device according to the present invention has an excellent float property and is therefore suitable as various electrochemical devices, particularly as a back-up power source.

### REFERENCE MARKS IN THE DRAWINGS

10: electrode group

11: positive electrode

111: positive current collector

112: carbon layer

113: active layer

12: negative electrode

13: separator

14: fastening tape

100: electrochemical device

101: container

102: sealing body

103: base plate

104A, 104B: lead wire

105A, 105B: lead tab

1. An electrochemical device comprising:
a positive electrode containing a positive electrode active material;
a negative electrode containing a negative electrode active material; and
an electrolytic solution, wherein:
the positive electrode active material includes a conductive polymer,
the electrolytic solution includes a lithium salt and a nonaqueous solvent,
the nonaqueous solvent includes a first solvent and a second solvent,
the first solvent includes γ-butyrolactone, and
the second solvent includes at least one selected from the group consisting of an unsaturated cyclic carbonate ester and a cyclic carboxylic acid anhydride.

2. The electrochemical device according to claim 1, wherein the second solvent includes both the unsaturated cyclic carbonate ester and the cyclic carboxylic acid anhydride.

3. The electrochemical device according to claim 1, wherein the unsaturated cyclic carbonate ester includes vinylene carbonate.

4. The electrochemical device according to claim 1, wherein the cyclic carboxylic acid anhydride includes at least one selected from the group consisting of maleic anhydride and succinic anhydride.

5. The electrochemical device according to claim 1, wherein a proportion of the second solvent in the nonaqueous solvent ranges from 0.1% by mass to 10% by mass, inclusive.

6. The electrochemical device according to claim 1, wherein the nonaqueous solvent further includes at least one selected from the group consisting of ethylene carbonate and methyl propionate.

7. The electrochemical device according to claim 1, wherein a proportion of γ-butyrolactone in the nonaqueous solvent other than the second solvent is more than or equal to 50% by mass.

8. The electrochemical device according to claim 1, wherein the conductive polymer includes polyaniline or a derivative of polyaniline.
